(19) United States
(12) Patent Application Publication
(10) Pub. No.: US 2012/0182477 A1
(43) Pub. Date: Jul. 19, 2012

(54) MOBILE DEVICE WITH A TOUCH SCREEN AND METHOD FOR CONTROLLING DIGITAL BROADCAST VIA TOUCH EVENTS CREATED IN THE DEVICE

(75) Inventors: Byoung Tack ROH, Gyeonggi-do (KR); Hee Deog KIM, Gyeonggi-do (KR)

(73) Assignee: Samsung Electronics Co., LTD., Gyeonggi-Do (KR)

(21) Appl. No.: 13/346,803

(22) Filed: Jan. 10, 2012

(30) Foreign Application Priority Data
Jan. 14, 2011 (KR) 10-2011-0003941

(51) Int. Cl. H04N 5/445

(52) U.S. Cl. 348/563; 348/E05.102

(57) ABSTRACT

A mobile device with a touch screen and a method for controlling digital broadcasts according to touch events that occur in the device includes: outputting broadcast data in a digital broadcast mode; tracking, when a touch event occurs during the output of the broadcast data, the movement of the touch event; identifying control-stroke information regarding a stroke of the tracked touch event; and performing a function corresponding to the identified control-stroke information. The mobile device can perform a variety of functions according to the movement of touch events sensed by the touch screen while outputting broadcast data.

### CLAIM OF PRIORITY

This application claims the benefit of priority from Korean Patent Application Serial No.:10-2011-0003941 filed Jan. 14, 2011, the contents of which are incorporated by reference in its entirety.

### BACKGROUND OF THE INVENTION

1. Field of the Invention

The present invention relates to mobile communication systems. More particularly, the present invention relates to a mobile device with a touch screen and a method that controls digital broadcasts via touch events sensed by the touch screen.

2. Description of the Related Art

With the development of communication technology, mobile devices now include an ever-increasing variety of functions. Such variety of functions include, for example, a data transmission/reception function to the other mobile devices, a function for playback data stored in the storage unit, such as MP files or videos, an Internet function, a digital broadcasting function, etc. In particular, the digital broadcasting function allows mobile device users to view digital broadcasts irrespective of where they are located.

However, conventional mobile devices cause a great deal of inconvenience when the users attempt to switch channels while viewing digital broadcasts. In the conventional mobile devices, a number of steps must be performed in order to switch from one channel to another. More specifically, when a user of a mobile device switches channels, he/she must select a channel list, identify channels in the list displayed on the mobile device, search the list for a corresponding channel, and then select the desired channel. In other words, switching channels is not easily performed in conventional mobile devices when compared with other devices such as television sets.

Therefore, there is a need in the art for a mobile device with a touch screen and a method for controlling digital broadcasting via touch events that occur in the device, which are proposed in this patent application.

### SUMMARY OF THE INVENTION

An exemplary aspect of the present invention is to address at least some of the above-mentioned problems and/or disadvantages and to provide at least the advantages described below.

In accordance with an exemplary aspect of the present invention, a method for controlling digital broadcasts is provided, which preferably includes outputting broadcast data in a digital broadcast mode; tracking, when a touch event occurs during the output of the broadcast data, the movement of the touch event; identifying control-stroke information regarding a stroke of the tracked touch event; and performing a function corresponding to the identified control-stroke information.

In accordance with an exemplary aspect of the present invention, a mobile device for controlling digital broadcasts is provided, which preferably includes a touch screen, the touch screen being part of a display unit for displaying the broadcast data and includes touch sensors for sensing touch events that occur on the display unit during the output of the broadcast data; a controller for tracking, when a touch event is sensed via the touch sensors while the broadcast data is being output on the display unit in a digital broadcast mode, the movement of the touch event, and for performing a function according to control-stroke information corresponding to the stroke of the tracked touch event; and a storage unit for storing the control-stroke information under the control of the controller.

### BRIEF DESCRIPTION OF THE DRAWINGS

FIG. 1 illustrates a schematic block diagram of a configuration of a mobile device according to an exemplary embodiment of the invention;

FIG. 2 illustrates output display screens that indicate an exemplary procedure to switch channels, according to an exemplary embodiment of the invention;

FIG. 3 illustrates screens that indicate how a user records a broadcast, according to an exemplary embodiment of the invention;

FIG. 4 is a flow chart that illustrates exemplary operation of a digital broadcast controlling method according to an exemplary embodiment of the invention; and

FIG. 5 is a flow chart that describes a control-stroke setting method according to an exemplary embodiment of the invention.

### DETAILED DESCRIPTION

The following description with reference to the accompanying drawings is provided to assist a person of ordinary skill in the art with a comprehensive understanding of exemplary embodiments of the presently claimed invention as defined by the claims and their equivalents. The description includes various specific details provided for illustrative purposes to assist in that understanding but these are not to be regarded as limiting the claimed invention to the examples shown and described herein. Accordingly, those of ordinary skill in the art will recognize that various changes and modifications of the exemplary embodiments described herein can be made without departing from the scope and spirit of the invention as defined by the appended claims. In addition, descriptions of well-known functions and constructions may be omitted for the sake of clarity and conciseness when their inclusion might obscure appreciation by the artisan of the claims subject matter of the present invention.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Moreover, the term ‘stroke’ as used herein typically refers to information that connects the movement coordinates of a touch event sensed on the touch screen and expresses them via the connection lines.

The term ‘mobile device’ as used herein typically refers to portable wireless communication devices to provide convenience to users, and includes all information communication devices, multimedia devices, and their applications, such as mobile communication devices that can provide digital broadcasting services, Digital Multimedia Broadcast (DMB) receivers, Personal Digital Assistants (PDAs), smartphones, tablet computers, etc.

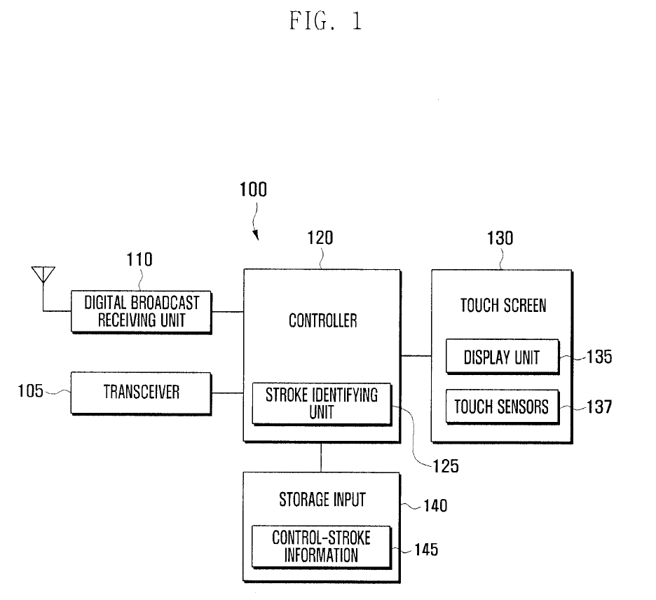

FIG. 1 illustrates a schematic block diagram of a configuration of a mobile device 100 according to an exemplary embodiment of the invention.

Referring now to FIG. 1, the mobile device preferably includes a digital broadcast receiving unit 110, a controller 120, a touch screen 130, and a storage input 140. The storage input comprises a non-transitory machine readable medium.

The digital broadcast receiving unit 110 receives broadcast data from a broadcasting center. To receive satellite DMB data, the digital broadcast receiving unit 110 would serve as a satellite DMB receiving module. Alternatively, the digital broadcast receiving unit 110 may serve as a terrestrial DMB receiving module to receive terrestrial DMB data. The digital broadcast receiving unit 110 includes a tuner that tunes frequencies to corresponding channels to receive broadcast data. The digital broadcast receiver thus receives and transmits wireless communication in a number of wireless communication protocols.

The controller 120, which preferably comprises a microprocessor or processor, controls the overall operation and state of the other components in the mobile device. In a digital broadcast mode, the controller 120 performs functions according to the movement of a touch event sensed by the touch screen 130. More specifically, the controller 120 identifies a stroke according to the movement of a touch event sensed by the touch screen 130. The controller 120 then determines whether or not the identified stroke is mapped to a function and, if the identified stroke is mapped to a function in storage, and performs the function. To this end, the controller 120 preferably includes a stroke identifying unit 125.

The stroke identifying unit 125 preferably identifies a stroke according to the movement of a touch event sensed by the touch screen 130 in a digital broadcast mode. The stroke identifying unit 125 recognizes coordinates, corresponding to regions where a touch event is sensed by the touch screen 130, as a line according to the movement track of the touch event. The stroke identifying unit 125, for example, determines whether or not the recognized stroke is included in control-stroke information 145 stored in the storage unit 140. The control stroke information can be updated via the digital broadcast receiving unit 110, or through an interface on a port of the portable terminal that may include, for example, a Universal Serial Bus (USB) port.

The mobile terminal may optionally include an RF transceiver 105, for example receiving and transmitting voice or video communications, text messages via SMS or some other protocol, pilot signals, etc. In conjunction with a codec and an A/D converter sounds from the user can be converted and transmitted as communication signals, and the reverse process for receiving and then listening to such communications.

The controller 120 performs a function associated with a particular stroke as recognized above. When the controller 120 performs a digital broadcast mode, the controller outputs to the display unit 135, broadcast data that is received via a channel that was selected in a digital broadcast mode that had been previously executed or via a channel selected by the user.

When the controller 120 senses a touch event via the touch screen 130 while outputting broadcast data, the controller tracks the movement of the sensed touch event. After that, the controller 120 determines whether or not control-stroke information corresponding to the stroke of the tracked touch event is stored in the storage unit 140.

When the controller 120 ascertains that the control-stroke information is stored in the storage unit 140, the controller identifies a function corresponding to the control-stroke information and then performs the associated function. Examples of the function are channel switching, broadcast recording, volume muting, etc.

With continued reference to FIG. 1, the controller 120 also determines whether or not a control-stroke setting is selected via a menu, etc., in a digital broadcast mode. When the controller 120 ascertains that a control-stroke setting has been selected, the control can be configured to map the stroke input by the user to a function selected thereby and then stores the associated function preferable in a map table, as control-stroke information 145, in the storage unit 140.

More specifically, the controller 120 displays a control-stroke input window to which the user inputs a stroke. When the user inputs a stroke to the control-stroke input window, the controller 120 identifies the input stroke. The controller 120 displays a function selection window on the display unit 135. On the function selection window, functions are displayed that can be performed in a digital broadcast mode, such as channel switching, power on/off, volume muting, etc. When a channel switching menu is selected, the controller 120 displays a submenu of all channels via which broadcast data is received in a digital broadcast mode. The controller 120 maps channels selected by the user to respective strokes and stores them in the storage unit 140 of the mobile terminal. Thus, the strokes can be used to individually configure a user's mobile terminal as desired.

The touch screen 130 preferably includes a display unit 135 and touch sensors 137 arranged on the display unit 135. The display unit 135 displays menus of the mobile device, and information input by the user or provided to the user. The display unit 135 may be implemented with a liquid crystal display (LCD). However, other thin-film technology such as Organic Light Emitting Diodes (OLED), Active Matrix Organic Light Emitting Diodes (AMOLED), Super AMOLED, PMOLED, or LED, just to name a few possibilities. In an exemplary embodiment of the invention, the display unit 135 displays broadcast data under the control of the controller 120. The display unit 135 also displays a stroke according to the pattern of movement of a touch event sensed by the touch screen 130, under the control of the controller 120, while displaying broadcast data.

The touch sensors 137 attached to the display unit 135 sense touch events that occur on the display unit 135. The touch sensors 137 detect coordinates of a region where a touch event occurs, i.e., locations. The touch sensors 137 may be implemented with resistive overlay type sensors, capacitive overlay type sensors, ultrasonic reflective sensors, optical sensors, electronic inductive sensors, etc. The touch sensors 137 transfer, to the controller 120, coordinates to identify a stroke according to the movement of a touch event. It is also possible that in addition to stroke recognition, a gyrosensor can be included and movement of the entire mobile terminal in a certain predefined way can be used to supplement the stroke recognition.

The storage input 140, which comprises a non-transient machine readable medium, stores data that is created according to the states and operations of the components of the mobile device under the control of the controller 120. The storage unit 140 stores control-stroke information 145 that is created as functions are mapped to strokes. A corresponding function is performed when a stroke according to the movement of at least one touch event or at least one stroke is input and identified, under the control of the controller 120. For example, the control-stroke information 145 may be: information regarding that a stroke, corresponding to a number representing a channel number, is mapped to a channel switching function; information regarding that a stroke, corresponding to a letter representing a word recording, is mapped to a recording function; and a stroke, corresponding to a letter representing a word muting, is mapped to a volume muting function. The control-stroke information 145, as an example, is shown as the following table 1.

TABLE 1

| Strokes | Functions |
|---|---|
| 6 | Switch to Ch 6 |
| 9 | Switch to Ch 9 |
| 11 | Switch to Ch 11 |
| 13 | Switch to Ch 13 |
| 70 | Switch to Ch 70 |
| R | Record |
| S | Power off |
| P | Power on |
| M | Volume muting |

Although it is not shown in the drawings, it should be understood that the mobile device according to the invention may further include a variety of components to perform corresponding functions. For example, the device may further include a camera module for taking pictures/videos; a short-range RF communication module; an audio processing unit for processing audio data, etc.

As described above, the mobile device can identify strokes according to the movement of a touch event sensed by the touch screen 130 and then perform a function mapped to the identified stroke, in a digital broadcast mode. Therefore, the user can select and execute a corresponding function in the mobile device, without inputting a number of keys. While the strokes do not have to mimic the channel numbers, in a best mode this group of strokes are preferred because a user naturally understands and remembers this pattern of strokes without having to learn it.

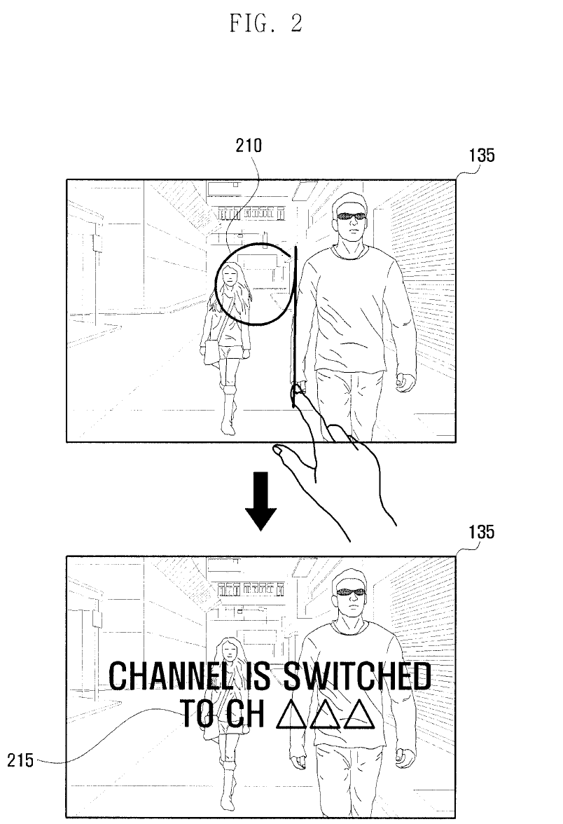

FIG. 2 shows screens indicating one example of how to switch channels, according to an exemplary embodiment of the invention.

Referring now to FIG. 2, the controller 120 controls the display unit 135 to display broadcast data received via a user's selected channel. When the user inputs the number ‘9’, labeled by 210, corresponding to the channel number to which he/she wants to switch, to the touch screen 130, the controller 120 tracks the movement of a touch event on the touch screen 130. The controller 120 compares the stroke of the tracked touch event with control-stroke information 145 stored in the storage unit 140.

Since the stroke of the tracked touch event has the shape of the number ‘9’ 210, the controller 120 determines whether control-stroke information 145 corresponding to the number ‘9’ 210 is stored in the storage unit 140. In an embodiment of the invention, it is assumed that the control-stroke information 145 corresponding to the number ‘9’ 210 includes a function for switching a channel to channel 9 and a stroke of the number ‘9.’

The controller 120 identifies the function to switch channels, i.e., which is mapped to a stroke of the shape of the number ‘9.’ After that, the controller 120 displays, on the display unit 135, a pop-up message 215 representing that the current channel is switched to the channel corresponding to the number ‘9,’ i.e., ‘channel is switched to CH Δ Δ Δ.’ The controller 120 controls the digital broadcast receiving unit 110 to receive broadcast data via a corresponding channel and displays it on the display unit 135.

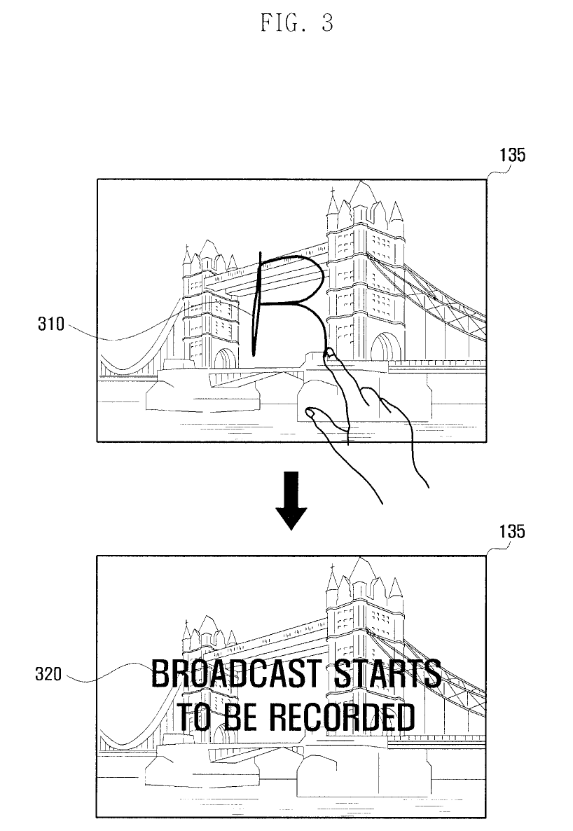

FIG. 3 shows screens that illustrate one example of how to record a broadcast, according to an exemplary embodiment of the invention.

Referring now to FIG. 3, the controller 120 controls the display unit 135 to display broadcast data received via a user's selected channel. When the user inputs the letter ‘R’, labeled by 310, to the touch screen 130 in order to record the currently reproduced broadcast data, the controller 120 tracks the movement of a touch event on the touch screen 130. The controller 120 compares the stroke of the tracked touch event with control-stroke information 145 stored in the storage unit 140.

Since the stroke of the tracked touch event has the shape of the letter ‘R’ 310, the controller 120 determines whether control-stroke information 145 corresponding to the letter ‘R’ 310 is stored in the storage unit 140. In an exemplary embodiment of the invention, it is assumed that the control-stroke information 145 corresponding to the letter ‘R’ 310 includes a recording function and a stroke of the letter ‘R.’ In addition, one can input “R9” which can mean for example, record channel 9, causing the controller to switch to channel 9 and begin recording. In addition, instructions for being a recording and ending a recording of a channel can be programmed into the mobile terminal by using predetermined strokes that are configured in storage (such as the map table) and can be performed by the controller.

The controller 120 identifies the recording function, i.e., which is mapped to a stroke of the shape of the letter ‘R.’ After that, the controller 120 displays, on the display unit 135, a pop-up message 315 ‘Recording broadcast data starts.’ The controller 120 records and stores the broadcast data that is received in the storage unit 140.

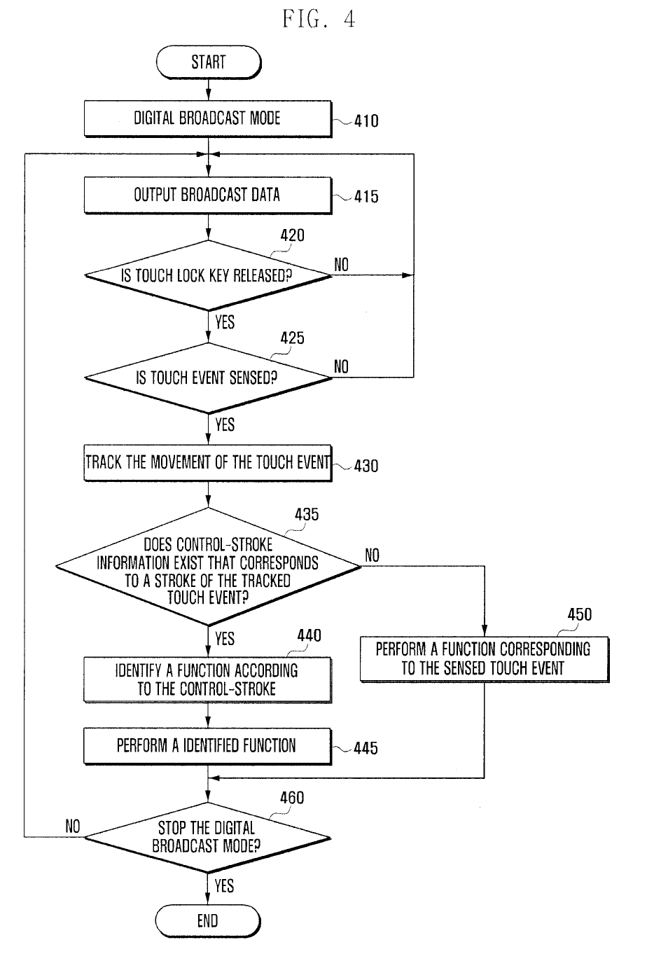

FIG. 4 illustrates a flow chart that describes a digital broadcast controlling method according to an exemplary embodiment of the invention.

Referring now to FIG. 4, at (410), the controller 120 operates in a digital broadcast mode according to a user's selection. The controller 120 outputs, to the display unit 135, broadcast data that is received via a channel that was selected in a digital broadcast mode that had been previously executed or via a channel selected by the user (415).

The controller 120 determines at (420) whether a touch lock key is released during the outputting of broadcast data. The releasing of a touch lock key may be omitted according to the setting of the mobile device or the mobile device manufacturer's selection.

When a touch lock key is released at step 420, then at (425) the controller 120 determines whether or not a touch event is sensed by the touch screen 130.

When the touch screen 130 senses a touch event at step 425, then at (430) the controller 120 tracks the movement of the sensed touch event. The controller 120 determines at (435) whether or not control-stroke information 145 corresponding to the stroke of the tracked touch event is stored in the storage unit 140.

When control-stroke information 145 is stored in the storage unit 140 at step 435, then at (440) the controller 120 identifies a function corresponding to the control-stroke information 145, followed by at (445) the controller controlling or performing the function. Examples of the function are channel switching, broadcast recording, volume muting, picture within picture, changing brightness of the display etc.

On the contrary, at (450) when control-stroke information 145 is not stored in the storage unit 140 at step 435, the controller 120 performs a function corresponding to the sensed touch event. That is, when the controller 120 senses a touch event, the controller identifies a region where it occurs. After that, the controller 120 performs a function mapped to the identified region. For example, the controller 120 may display a list of channels according to a function mapped to the region where the touch event occurs, a volume control menu, or details of currently reproduced broadcast data.

After that, the controller 120 determines at (460) whether or not a selection is made to terminate the digital broadcast mode. When the controller 120 ascertains that a selection is not made to terminate the digital broadcast mode at step 460, and the controller 120 proceeds to perform step 415.

Meanwhile, when a touch lock key is not released at step 420 or the touch screen 130 does not sense a touch event at step 425, the controller 120 proceeds to perform step 415.

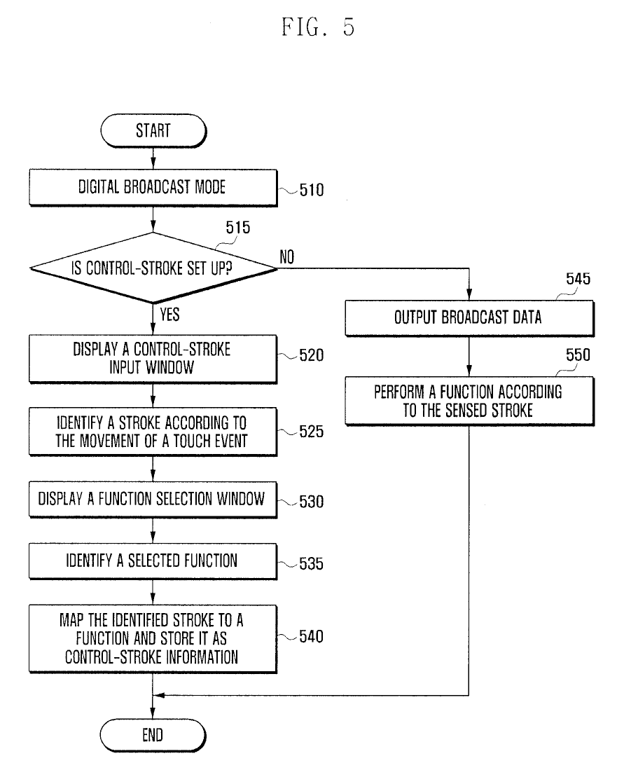

In the following description, a method is provided that maps strokes to functions and stores them, as control-stroke information 145, in the storage unit 140, referring to FIG. 5.

FIG. 5 illustrates a flow chart that describes a control-stroke setting method according to an embodiment of the invention.

Referring now to FIG. 5, at (510) the controller 120 operates in a digital broadcast mode according to a user's selection. At (515), the controller 120 determines whether a selection is made to set a control-stroke via a menu, etc. When at (515) a selection has been made to set a control-stroke via a menu, etc., the controller 120 at (520) displays a control-stroke input window on the display unit 135 (520). The controller 120 at (525) identifies a stroke according to the movement of a touch event sensed by the touch screen 130. The controller 120 displays the identified stroke on the display unit 135 so that the user can view the type of stroke that he/she input.

With continued reference to FIG. 5, at (530) the controller 120 displays a function selection window through which the user can select a function to be stored with a stroke. The function selection window displays all functions that can be performed in a digital broadcast mode, e.g., channel switching, recording, volume muting, etc. For example, when a channel switching menu is selected, the controller 120 displays a submenu of all channels via which the user can view broadcast data in a digital broadcast mode. Therefore, the user can easily select a channel to be switched according to his/her input stroke.

At (535) the controller 120 identifies a function that the user selects via the function selection window. The controller 120 at (540) maps the identified stroke to a function and stores the information in storage, such as control-stroke information, in the storage unit 140.

Although the exemplary embodiment is implemented in such a way that the controller 120 displays, on the display unit 135, a control-stroke input window and then a function selection window, a person of ordinary skill in the art should understand that the presently claimed invention is not limited to the exemplary embodiment. For example, the embodiment may be modified in such a way that the controller 120 displays the function selection window first and then, if a function is selected, the control-stroke input window that the user can input a stroke. After that, the controller 120 maps the input stroke to a function and then stores it in the storage unit 140.

Meanwhile, when the controller 120 ascertains that a selection is not made to set a control-stroke via a menu, etc. at step 515, the controller outputs broadcast data according to a user's selection (545). Then at (550), the controller 120 performs a function according to a stroke sensed via the touch screen 130 (550). In other words, as described above referring to FIG. 4, when the controller 120 senses a touch event via the touch screen 130, the controller identifies a stroke according to the movement of the touch event. The controller 120 determines whether control-stroke information 145 corresponding to the identified stroke is stored in the storage unit 140. When the controller 120 ascertains that control-stroke information 145 is stored in the storage unit 140, the controller performs a function corresponding to the stroke.

As described above, the mobile device according to the presently claimed invention can perform a variety of functions according to the movement of touch events sensed by the touch screen 130 while outputting broadcast data. Therefore, the user does not need to check channels in the list, one by one, in order to switch channels in a digital broadcast mode, or learn some arcane way of changing channels. The user can select a particular function, such as recording, volume muting, etc., without performing the inputting of a number of keys, while viewing a broadcast.

As described above, the mobile device and method according to the invention allows the user to control a DMB function via a simple input while viewing digital broadcasts. The user can easily execute a particular function, such as channel switching, recording, etc., without inputting a number of keys, and can use his/her finger or a stylus, for example.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A method for controlling digital broadcasts, comprising:
outputting broadcast data by a controller in a digital broadcast mode;
tracking by the controller when a touch event is sensed via the touch sensors indicating movement constituting a stroke occurs during the output of the broadcast data, the movement of the touch event;
identifying control-stroke information from storage regarding a stroke of the tracked touch event; and
performing by the controller a function corresponding to the identified control-stroke information.

2. The method of claim 1, further comprising:
displaying on the display unit a control-stroke input window when a selection is made to set up the control-stroke information;
identifying a stroke according to the types of movements of the touch events input to the control-stroke input window and compared with associated functions in storage; and
mapping, when a function to be mapped to the stroke is selected, the stroke to the function and storing the selected function as control-stroke information.

3. The method of claim 2, wherein the function to be mapped comprises one of channel switching, recording, muting, and volume controlling.

4. The method of claim 2, wherein the identifying of control-stroke information comprises:
identifying a stroke according to the movement of the tracked touch event on the touch screen;
determining whether or not control-stroke information corresponding to the stroke exists; and
identifying, when control-stroke information exists, a function mapped to the control-stroke information.

5. The method according to claim 2, wherein a plurality of integers and associated strokes are mapped to storage, and when the controller determine that a stroke corresponds to one of the plurality of integers, the controller changes the channel associated with strokes that comprise written numerals corresponding to one of the plurality of integers.

6. The method according to claim 2, wherein a particular predetermined combination of strokes comprising letters and numbers recognized by the controller provides a function of switching to a specific channel number and a start and stop time of a video recording.

7. The method according to claim 2, wherein the display screen comprises a plurality of sensors that senses user motion on the display touch screen.

8. The method according to claim 2, wherein a digital broadcast receiving unit receiving broadcasts via Digital Video Broadcasting Handheld (DVB-H).

9. The method according to claim 10, wherein the mobile terminal receives broadcasts via Eureka 147.

10. A mobile device for controlling digital broadcasts comprising:
a touch screen including a display unit for displaying the broadcast data and touch sensors for sensing touch events that occur on the display unit during the output of the broadcast data;
a controller for tracking, when a touch event is sensed via the touch sensors while the broadcast data is being output on the display unit in a digital broadcast mode, the movement of the touch event, and for performing a function according to control-stroke information corresponding to the stroke of the tracked touch event; and
a storage unit for storing the control-stroke information under the control of the controller.

11. The mobile device of claim 10, wherein the controller controls the display unit to display a control-stroke input window when a selection is made when setting up the control-stroke information, identifies a stroke according to the types of movements of the touch events input to the control-stroke input window, and maps, when a function to be mapped to the stroke is selected, the stroke to the function, and stores it, as control-stroke information, in the storage unit.

12. The mobile device of claim 11, wherein the function mapped to the stroke comprises one of channel switching, recording, muting, and volume controlling.

13. The mobile device of claim 10, wherein the controller identifies a stroke according to the movement of the tracked touch event, determines whether control-stroke information corresponding to the stroke exists in the storage unit, and identifies, when control-stroke information exists, a function mapped to the control-stroke information.

14. The mobile device of claim 10, further comprising a transceiver for performing one of a voice communication, video communication, or a multimedia communication.

15. The mobile device of claim 11, wherein the touch screen comprises one of an Liquid Crystal Device (LCD), Light Emitting Diode (LED), Organic Light Emitting diode (OLED), Active Matrix Light Emitting Diode (AMOLED), SUPER AMOLED, a PMOLED.

16. The mobile device of claim 10, further comprising a digital broadcast receiving unit that receives broadcasts via Digital Video Broadcasting Handheld (DVB-H).

17. The mobile device according to claim 10, wherein the mobile terminal receives broadcasts via Eureka 147.

18. The mobile device according to claim 13, wherein a plurality of integers and associated strokes are mapped to storage, and when the controller determines that a stroke corresponds to one of the plurality of integers, the controller changes the channel associated with strokes that comprise written numerals corresponding to one of the plurality of integers.

19. The mobile device according to claim 13, wherein a particular predetermined combination of strokes comprising letters and numbers recognized by the controller provides a function of switching to a specific channel number and a start and stop time of a video recording of the specific channel.
